(19) United States
(12) Patent Application Publication
(10) Pub. No.: US 2007/0273477 A1
(43) Pub. Date: Nov. 29, 2007

(54) Programmable remote control for multiple vehicles and method of use

(76) Inventor: Baron Philipson, Davie, FL (US)

Correspondence Address: HEDMAN & COSTIGAN P.C., 1185 AVENUE OF THE AMERICAS, NEW YORK, NY, 10036, US

(21) Appl. No.: 11/431,964

(22) Filed: May 11, 2006

(51) Int. Cl. B60R 25/00

(52) U.S. Cl. 340/5.72; 340/825.72; 340/5.64; 341/176; 340/426.13; 340/5.61; 340/5.22

(57) ABSTRACT

A system and method for remotely unlocking, locking, and opening the trunk of multiple vehicles. Each function of each vehicle is controlled via a single remote control device. The remote control device has the capability of being trained to control new vehicles as they are obtained by the user.

### FIELD OF THE INVENTION

The invention relates to a programmable remote control that allows a user to lock, unlock, and open the doors and trunk and to control the alarm system of more than one vehicle. The remote control is programmed so that only one vehicle is controlled at a time.

### BACKGROUND OF THE INVENTION

Remote controls for locking, unlocking, opening doors, and controlling the alarm systems of vehicles have been available for many years, so it is no longer a strange sight when someone unlocks a car door from several feet away. Most people today readily recognize the audible beeps that signal when a vehicle's alarm has been either armed or disarmed by a remote control used by the owner. It is also not uncommon for people to own more than one vehicle, which creates the need for multiple remote controls; while relatively small, these remote controls can be somewhat bulky so that it is inconvenient to carry two or more of them. Furthermore, if a user were to purchase another vehicle, that vehicle would have its own remote control, thus adding to the user's collection. The prior art has tried, and failed, to remedy this inconvenience.

For example, U.S. Pat. No. 6,346,876 by Flick teaches a multi-vehicle compatible control system which generates command signals on a data bus and associated methods. The control system includes a transmitter and a receiver, and a multi-vehicle compatible controller that cooperates with the transmitter and receiver. The controller generates multiple signals or codes, but only one signal will cause a response in a vehicle.

U.S. Pat. No. 6,223,029 to Stenman et al. discloses a mobile station that has communications functionalities. The mobile station is able to remotely control a variety of peripheral devices through user-provided inputs. The mobile station accesses these devices through wireless telephony networks.

U.S. Pat. No. 5,828,316 to DiCroce provides a system to allow a user to expand and increase the abilities of a remote control vehicle security system. That is, since most standard remote controls allow only door locking, door unlocking, and trunk opening, DiCroce provides a way to allow the user to add functions such as starting the engine without need for a second installation of hardware.

U.S. Pat. No. 5,650,774 by Drori teaches a remote control access system which comprises one or more hand held remote transmitters and a receiver unit. This allows the receiver to be operable with a multiple number of transmitters.

### SUMMARY OF THE INVENTION

The present invention allows for a single remote control device that a user can easily carry along on a keychain or in a pocket, purse, backpack, etc. The user can train the remote control device to function with numerous vehicles and to control various functions for each of the numerous vehicles. No additional hardware installation in the vehicle is required, as long as the vehicle already possesses the proper system to receive signals.

It is therefore an object of the present invention to reduce the number of remote control devices a user who owns more than one vehicle must carry. It is a further object of the present invention to allow the user to use the same remote control device even after relinquishing possession of one vehicle and gaining possession of another vehicle. It is an even further object of the present invention to allow one remote control device to be compatible with multiple vehicles of various manufacturers. It is yet a further object of the present invention to allow one remote control device to be compatible with vehicles capable of receiving various types of signals.

The present invention achieves these and other objectives wherein it is directed to a remote control device with the capability of sending one or more signals to each of several vehicles. The remote control device includes one or more buttons, a switch for selecting each vehicle, a signal emitter, and a signal receiver.

### BRIEF DESCRIPTION OF THE DRAWINGS

The attached drawing figures, in which like reference characters represent like parts, are included solely to illustrate the preferred embodiment of the present invention without limiting the invention in any manner whatsoever, wherein:

FIG. 1 is a drawing of a remote control for controlling two vehicles.

FIG. 2 is a drawing of a remote control for controlling three vehicles.

### DETAILED DESCRIPTION OF THE PRESENT INVENTION

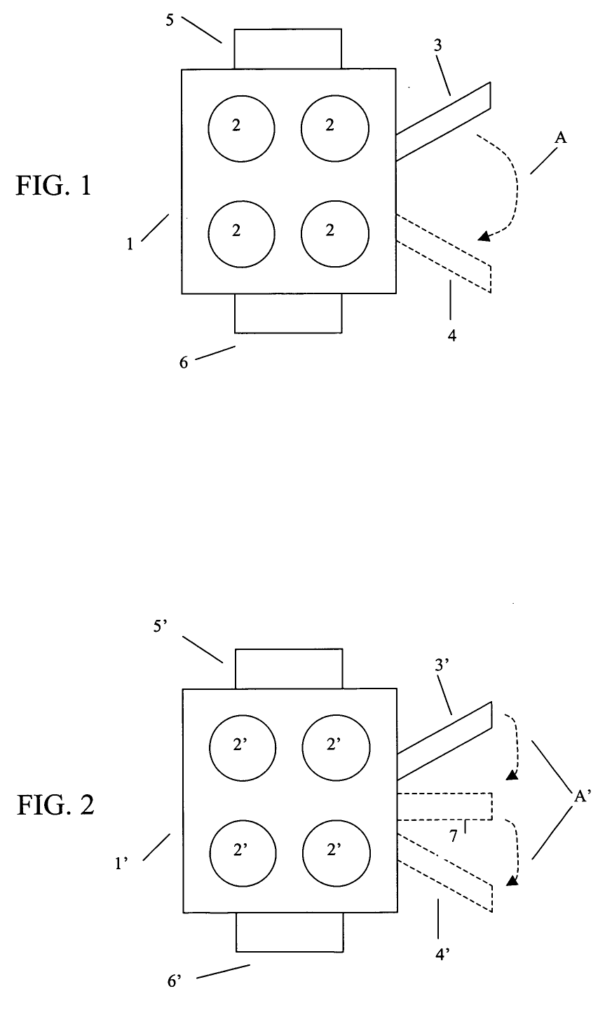

As best shown in FIG. 1, a remote control device (1) contains a plurality of buttons (2). Each button (2) controls a different function, for example, unlocking vehicle doors, locking vehicle doors, opening the vehicle trunk, sounding vehicle alarm, etc. FIG. 1 shows only four buttons (2), but any number of buttons that can fit onto the remote control device (1) is envisioned. Attached to the remote control device (1) is an emitter (5) and a receiver (6). The switch (3) is in the “up” position, thus controlling a first vehicle. If the switch is pushed downward (4) via the arrow (A), the remote control device (1) controls a second vehicle.

The emitter (5) on the remote control device (1) emits the signal that is received by the vehicle. This signal can be any type of wirelessly transmitted signal, such as radio frequency (RF), infrared (IR), etc.

The receiver (6) on the remote control device (1) is what allows the invention to control multiple vehicles. If one of the positions of the switch (3 or 4) is unused, then a user, when desiring to add a vehicle to an unused spot on the remote control device (1) must press the switch to the unused spot. Then, the user simply presses a series of predetermined buttons (2) to place the remote control device (1) into training mode. While in training mode, the remote control device (1) receives signals through the receiver (6) and records any signal that it senses. Therefore, the user must activate the original remote that came with the vehicle, thus giving the remote control device (1) a signal to record. A button (2) is then pressed so the recorded signal is assigned to that button. Finally, the user must press the same or a different series of predetermined buttons (2) to deactivate training mode, thus placing the remote control device (1) back into normal mode. The remote control device (1) can now mimic any function for which it has recorded a signal.

The computer programs and electronic components necessary to practice the present invention can be assembled from various commercial sources known to those skilled in the art. Some examples of the necessary computer programs and electronic circuitry that may be used in the present invention are described in U.S. Pat. Nos. 6,346,876; 6,223,029; 5,828,316; and 5,650,774 which are incorporated herein by reference.

FIG. 2 shows a remote control device (1′) that controls three vehicles. The remote control device (1′) works in a manner similar to the remote control device (1) in FIG. 1, with the exception that there are three switch positions to choose from (3′, 4′, or 7). The user presses the switch between these three positions via the arrows (A′), thus allowing control of three vehicles. The training mode works in the same manner as previously described, with the exception that the user can now select from three switch positions (3′, 4′, or 7) as opposed to two switch positions (3 or 4). It is possible to control many more than three vehicles, the only limiting factor being the size of the remote control device (1 or 1′).

Having described the present invention, it will now be apparent that many changes and modifications may be made to the above-described embodiments without departing from the spirit and the scope of the present invention.

1. A remote control device capable of controlling a plurality of vehicles comprising:
a. one or more buttons;
b. a switch capable of being in one of at least two positions;
c. a signal emitter; and
d. a signal receiver.

2. The remote control device of claim 1 wherein said device is a computer and said one or more buttons and said switch are virtual, existing on a screen of said computer as representations of buttons and a switch.

3. The remote control device of claim 1 wherein said one or more buttons controls at least one function selected from the group of functions consisting of the locking of a door, the unlocking of a door, the sounding of an alarm, the opening of a trunk, and the ignition of a vehicle.

4. A method for controlling a plurality of vehicles comprising the steps of:
a. pressing a switch on a remote control device to select one vehicle of a plurality of vehicles;
b. pressing a button on said remote control device to cause a function in said one vehicle and, optionally, pressing a second, third, fourth, etc. button on said remote control device to cause a second, third, fourth, etc. function in said one vehicle;
c. pressing said switch on said remote control device to select a second vehicle of said plurality of vehicles; and
d. pressing said button on said remote control device to cause a function in said second vehicle and, optionally, pressing a second, third, fourth, etc. button on said remote control device to cause a second, third, fourth, etc. function in said second vehicle.

5. A method for training a remote control device to communicate with a vehicle comprising the steps of:
a. selecting a location in said remote control device in which to store information;
b. placing said remote control device into a training mode;
c. providing a signal;
d. copying said signal to said remote control device;
e. associating said copied signal in said remote control device with a button located on said remote control device; and
f. causing said remote control device to cease being in said training mode.

6. The method of claim 5 wherein said remote control device can be trained to recognize a signal for a plurality of vehicles.

7. The method of claim 5 wherein said remote control device can be trained to recognize a plurality of signals for a single vehicle.

8. The method of claim 5 wherein said remote control device can be trained to recognize a plurality of signals for a plurality of vehicles.
